(19) United States
(12) Patent Application Publication
(10) Pub. No.: US 2012/0275501 A1
(43) Pub. Date: Nov. 1, 2012

(54) PLUGGABLE SYNCHRONIZATION CLOCKS, NETWORKS, SYSTEMS AND METHODS RELATED THERETO

(76) Inventor: Sergiu Rotenstein, Chatsworth, CA (US)

(21) Appl. No.: 13/458,962

(22) Filed: Apr. 27, 2012

Related U.S. Application Data
(60) Provisional application No. 61/479,670, filed on Apr. 27, 2011.

(51) Int. Cl. H04B 1/38; H04L 7/00

(52) U.S. Cl. 375/220; 375/219; 375/358

(57) ABSTRACT

A pluggable synchronization clock comprising: a pluggable transceiver and a system clock synchronization subsystem embodied within the pluggable transceiver. The system clock synchronization subsystem may be adapted to implement a packet based precision time protocol. The system clock synchronization subsystem may be further adapted to include a time stamp unit capable of adding a time stamp to a frame using hardware or software.

This application claims the benefit of U.S. Provisional Application No. 61/479,670, filed Apr. 27, 2011, which is hereby incorporated by reference

### FIELD

The present patent document relates to system synchronization clocks embodied in a pluggable form factor and networks, systems and methods related thereto.

### BACKGROUND

It is very often important for devices that reside on communication networks to have their system clocks synchronized. With the emergence of Carrier Ethernet and the migration of wireless backhaul from Plesiochronous Digital Hierarchy (PDH) and Synchronous Optical Networking Technologies (SONET)/Synchronous Digital Hierarchy (SDH) based networks to Ethernet based backhaul, the need for network clock synchronization has increased dramatically. However, accurate synchronization is very difficult to achieve without dedicated hardware.

While protocols exist that address the needs for a packet protocol for clock distribution, such protocols loose considerable accuracy when implemented purely in software and require hardware assistance to assure the precise accuracies desired. Furthermore, today's Carrier Ethernet networks comprise large quantities of Carrier Ethernet devices (switches, routers, network interface devices (NIDs)) that have no capability to implement clock distribution protocols either in software or hardware.

### SUMMARY OF THE PREFERRED EMBODIMENTS

In view of the foregoing, an object according to one aspect of the present patent document is to provide a synchronization clock embodied within a pluggable transceiver. Preferably the apparatuses and methods address, or at least ameliorate one or more of the problems described above. To this end, a pluggable synchronization clock is provided. The pluggable synchronization clock comprises a pluggable transceiver and a system clock synchronization subsystem embodied within the pluggable transceiver.

In one embodiment, the system clock synchronization subsystem is adapted to implement a packet based precision time protocol. In another embodiment, the system clock synchronization subsystem is adapted to perform a first portion of the precision time protocol and further adapted to interface with a host system adapted to perform a second portion of the precision time protocol.

In yet another embodiment, the system clock synchronization subsystem further includes a timestamp unit. In various embodiments, the timestamp unit is adapted to timestamp a frame in hardware. In other embodiments, the timestamp unit is adapted to timestamp a frame in software.

In another aspect of the present patent document, a pluggable transceiver is provided. The pluggable transceiver comprises a system clock synchronization subsystem, a first interface and a second interface. The first interface is in communication with the system clock synchronization subsystem and is adapted to receive packets from an external network. The second interface is in communication with the system clock synchronization subsystem and is adapted to communicate with a host system.

In one embodiment, the system clock synchronization subsystem further comprising a time stamp unit. The time stamp unit may be adapted to time stamp packets using hardware. In other embodiments, the system clock synchronization subsystem may further include a processor unit that is adapted to time stamp packets in software.

In another embodiment, the system clock synchronization subsystem is adapted to process packets that conform with a precision time protocol. In certain of those embodiments, the precision time protocol conforms with the IEEE-1588v2 standard.

In yet another embodiment, the system clock synchronization subsystem is adapted to perform a portion of a precision time protocol and further adapted to communicate over the second interface with a host adapted to perform a second portion of the precision time protocol.

In another aspect of the present patent document, a method of synchronizing a time of a first clock with a time of a second clock is provided. The method comprises the steps of: receiving information about the time of the second clock on a first interface of a pluggable transceiver; and sending information about the time of the second clock on a second interface of the pluggable transceiver to a host device of the first clock.

In at least one embodiment, the method further comprises the step of synchronizing the time of the first clock with the time of the second clock. In various embodiments, the host device of the first clock is also the host device of the pluggable transceiver. In other embodiments, a host device of the second clock is also the host device of the pluggable transceiver.

In yet another embodiment of the method, the information about the time of the second clock is adapted to a precision time protocol standard.

In another aspect of the present patent document, a method of synchronizing a time of a device clock with a master clock is provided. The method comprises the steps of: receiving packetized information about the time of the master clock from a pluggable transceiver; calculating a transit time of the packetized information between the master clock and the device clock; and synchronizing the device clock with the master clock. In one embodiment of the method, the device clock is a component of a wireless base station.

In yet another aspect of the present patent document, a networking device with a system clock synchronization capability is provided. The networking device comprises: memory; a processor in communication with the memory; a system clock in communication with the processor; and executable instructions residing in the memory and adapted to be executed by the processor, wherein the executable instructions are designed to receive clock information from a pluggable transceiver via a host system interface and use the clock information to synchronize the system clock.

In one embodiment, the clock information is received in a packet format that is adapted to a precision time protocol standard.

### BRIEF DESCRIPTION OF THE DRAWINGS

FIG. 1 illustrates one embodiment of a synchronization clock embodied within a hot pluggable transceiver.

FIG. 2 illustrates a table of the pin signals in one embodiment of a synchronization clock embodied within a hot pluggable transceiver that conforms to a small form-factor pluggable format.

FIG. 3 illustrates an isometric view of one embodiment of a synchronization clock embodied within an hot-pluggable transceiver.

FIG. 4 illustrates one embodiment of a design architecture for a synchronization clock embodied within a pluggable transceiver.

FIG. 5 illustrates a master and slave device implementing the Delay Request Response Mechanism defined by the PTP.

FIG. 6 illustrates the basic synchronization message exchange.

FIG. 7 illustrates a master and slave device implementing the Peer Relay Mechanism defined by the PTP.

FIG. 8 illustrates the data flow in a PTP master slave architecture.

FIG. 9 illustrates a network running PTP for use in describing one example implementation including embodiments of the pluggable synchronization dock.

### DETAILED DESCRIPTION OF THE PREFERRED EMBODIMENTS

In the following description of the preferred embodiments, reference is made to the accompanying drawings that form a part of this patent document, and in which specific embodiments are shown by way of illustration. It is to be understood that other embodiments may be utilized and structural changes may be made without departing from the scope of the present patent document.

Consistent with its ordinary meaning, “hot pluggable transceiver” or “pluggable transceiver” (hereinafter HPT) includes any optical and/or other media transceiver that is pluggable. For example, HPT includes any transceiver that may be added or interposed into a system while the system is operational or non-operational. HPTs include transceivers adapted for any purpose including transceivers adapted and arranged to interface a network device motherboard to a fiber optic or copper networking cable (for a switch, router, media converter or other such devices). To this end, HPTs may be in any shape or customized design including any format or design which is suitable for the function for which the HPT is intended to perform. HPTs may also come in any form factor, including but not limited to formats such as SFP (Small Form-factor Pluggable), XFP (10 Gigabit Small Form Factor Pluggable), XENPAK, X2, QSFP, CFP and others. The definition of HPT is not limited by any particular form factor and HPTs may be in any form factor including form factors yet to be developed.

HPTs may be utilized for a number of applications including in any type of digital data transfer systems, various optical fiber communications systems, and communication networks. The present patent document teaches various embodiments of a system clock synchronization subsystem embodied within a HPT. In some preferred embodiments, a system clock synchronization subsystem that conforms with IEEE 1588 is embodied within a HPT. By providing a synchronization clock within a HPT, the synchronization clock may be dynamically added to any existing system design that accepts HPTs. The present patent document provides the means of adding system clock synchronization capabilities to any Ethernet system (ex. switch, router, bridge, hub, etc) equipped with an available pluggable transceiver network interface (ex. Fast Ethernet, or Gigabit Ethernet or 10G Ethernet). This allows systems to dynamically add a synchronization clock at any time.

The present patent document further teaches the operational and functional combination of synchronization clocks embodied in pluggable transceivers with their respective systems, networks, and the methods associated therewith. The various aspects of the embodiments relate also to hardware and software-enabled operational and functional systems, modules, networks, devices, apparatus and methods utilizing numerous possible combinations of hardware and software with system clock synchronization subsystems embodied in HPTs.

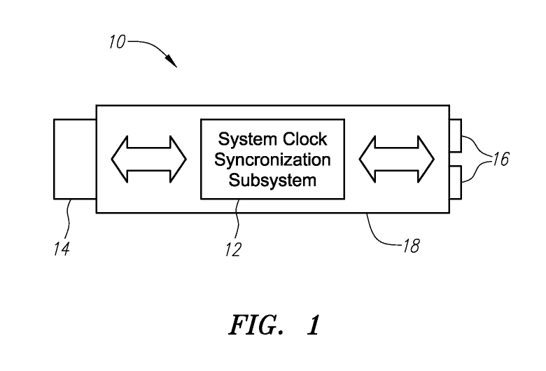

FIG. 1 illustrates one embodiment 10 of a system clock synchronization subsystem embodied within a HPT. Pluggable synchronization clock 10 includes a system clock synchronization subsystem 12 embodied within a HPT 18. HPT 18 includes a host system interface 14 and an external interface 16. The system clock synchronization subsystem 12 is in communication with the system interface 12 and the external interface 16. The host system interface 14 may be designed to be in data communication with a backplane of host device such as a router or switch. Pluggable synchronization clock 10 may communicate directly with the host system via the host system interface 14.

Pluggable synchronization clock 10, may be embodied in an HPT 18 adapted to operate at various different speeds including speeds from a few Megabits per second (Mbps) up to 10 Gigabits per second (Gbps). In other embodiments, pluggable synchronization clock 10 may operate at 40 Gbps or even 100 Gbps.

Generally speaking, the evolution of HPTs throughput is likely to evolve in parallel with the progress of networking technologies. Indeed, over the past years, new types of faster and smaller HPTs have been created. As an example of the evolution of HPTs, GBIC was one of the first HPTs to be created. Shortly after the introduction of GBIC, SFP; and 10G XENPAK became available, followed by X2, by XFP and now SFP+. In response to higher speed and capacity needs, the 40G and 100G industries created the QSFP+ and CFP interface, and are expected to create more types of such HPTs. New and/or faster HPT's will soon be available and the present patent document contemplates embodiments of pluggable synchronization clock 10 not only with existing technologies, but also embodiments of pluggable synchronization clock 10 adaptable for use with those yet to be developed faster technologies.

The system clock synchronization subsystem 12 is any subsystem adapted for use in synchronizing clocks on more than one device. For example, multiple devices on a communication network may all have an internal clock. System clock synchronization subsystem 12 may be used by itself or in combination with other system clock synchronization subsystems to allow the internal clocks to synchronize their time.

In preferred embodiments, the pluggable synchronization clock 10 may comply with one or more industry standards, such as the MSA (Multi-Source Agreement). Accordingly, pluggable synchronization clock 10 may be compatible with the equipment of numerous network component vendors. In addition, various embodiments of pluggable synchronization clock 10 may support one or multiple major communication protocols. For example, in various embodiments, pluggable synchronization clock 10 may support communication protocols such as SONET/SDH, Ethernet, Fiber Channel, or other communication protocols.

The pluggable synchronization clock 10 communicates with the host system through the host system interface 14. In embodiments where the pluggable synchronization clock 10 complies with an industry standard, the host system interface 14 between the pluggable synchronization clock 10 and the host system may also comply with a well defined electrical interface standard. Preferably in such embodiments, the electrical host system interface 14 comprises connector pins for: 1) Power supply—the system supplies power (VCC) to the transceiver; 2) Ground (TX and RX)—the system supplies reference ground to the transceiver Transmitter and Receiver circuitry; 3) I2C=Transceiver management bus. This slow management bus (I2C) allows provisioning and monitoring of the pluggable transceiver. Through this path, a hosting system can read the basic static transceiver information (transceiver type, manufacturer, serial number, maximum rate, etc.) as well as dynamic running time information (transmit power, receive power, bias current, operational alarms, etc.); 4) Data transfer—differential data TX and RX; 5) Other services like transmit enable or data rate select and/or error indication (TX Fault, LOS, etc.).

In a preferred embodiment, the host system interface includes a serial interface that uses Ethernet (ex. 100-FX or 1000-X or 10G SFI). In other embodiments, other networking protocols may be used. Using a networking protocol to communicate with the host system prevents any special handling by the host system because the data received from the pluggable synchronization clock 10 will be in conformity with the type of data the host system is designed to receive. This reduces the overhead and development of the host systems and makes the pluggable synchronization clock 10 compatible across a broad range of host system devices.

In a preferred embodiment, the pluggable synchronization clock primarily communicates with the host system via the data path (TX and RX) generally employed by the HPT hosting system to transmit and receive protocol data to/from the networking link. Communication between the host and the pluggable synchronization clock 10 via the data path is known as in-band access. In-band access may provide control to the host of both the HPT 18 and the system clock synchronization subsystem 12. For example, if the pluggable synchronization clock 10 is plugged into an Ethernet device (Ethernet switch or router or converter or plainly any computing system with a HPT Ethernet interface), communication may occur via Ethernet packets sent over the TX and RX lines.

The implementation of the in-band access between the host and the pluggable synchronization clock 10 may vary in range and complexity depending on the embodiment. There are numerous options, combinations and permutations of the range and complexity of the in-band access in embodiments that incorporate such access. Several of the preferred embodiments are, for example: 1) Simple layer 2 based proprietary access methods; and 2) Standard TCP/IP based protocols, like SNMP, HTTP, and other control protocols.

If the in-band access uses a simple layer 2 based proprietary access method, the access may be based on a proprietary simple Ethernet layer-2 packet based read/write protocol. Advantageously, no upper layer, like TCP/IP, must be employed. Security aspects in a system thus equipped may be done at the overall network access level.

If the in-band access use a control protocol such as SNMP or other control protocols, standard data security methods may be applied before transport. Any of the embodiments may further include provisioning, for example, of the TCP/IP parameters, security parameters or any other parameter.

In addition to in-band access, other channels of communication may exist as an alternative to or in addition to the data path. For example, the pluggable synchronization clock 10 may communicate with the host system via the slow management bus (I2C) intended for provisioning and monitoring of the HPT or via the special services lines for enabling activity, data rate selection or error/event monitoring. Various embodiments of the pluggable synchronization clock 10 may incorporate different communication methods or combinations thereof with the host system.

In one embodiment, the functionality of the HPT 18 and/or the system clock synchronization subsystem 12 may be initialized and configured/provisioned through the standard HPT bus (I2C) interface. In a preferred embodiment, the HPT 18 and/or the system clock synchronization subsystem 12 are initialized and configured/provisioned through standard MSA defined registers, however, in other embodiments; additional I2C based registers may be used.

Depending on the design of the pluggable synchronization clock 10, various data channels with the host system via the host system interface 14 may be used to control just about any aspect of the pluggable synchronization clock 10. However, in many preferred embodiments, the HPT I2C interface is the control interface. Through this interface, the hosting system may: 1) Enable/disable in-band provisioning access; 2) Enable/disable various modes of operation; Configure any appropriate in-band access parameters (depending on the specific in-band access implemented); Configure any protocol specific parameters, like for example real time clock setting and alignment. Furthermore, in many preferred embodiments, the special control and monitoring lines may be used for implementing specific tasks, like enabling or provisioning features or for error/event monitoring.

While the embodiment of the pluggable synchronization clock 10 shown in FIG. 1 has a single system clock synchronization subsystem 12 embodied within a single HPT 18, other embodiments may include other combinations of system clock synchronization subsystems 12 and HPTs 18. For example, multiple system clock synchronization subsystems 12 may be embodied within a single HPT 18. HPTs with multiple network interfaces (ex. CFP or QSFP) may accommodate multiple parallel system clock synchronization subsystems 12. In certain embodiments, these subsystems may share some redundant components. In other embodiments, the system clock synchronization subsystems 12 each have all their own components.

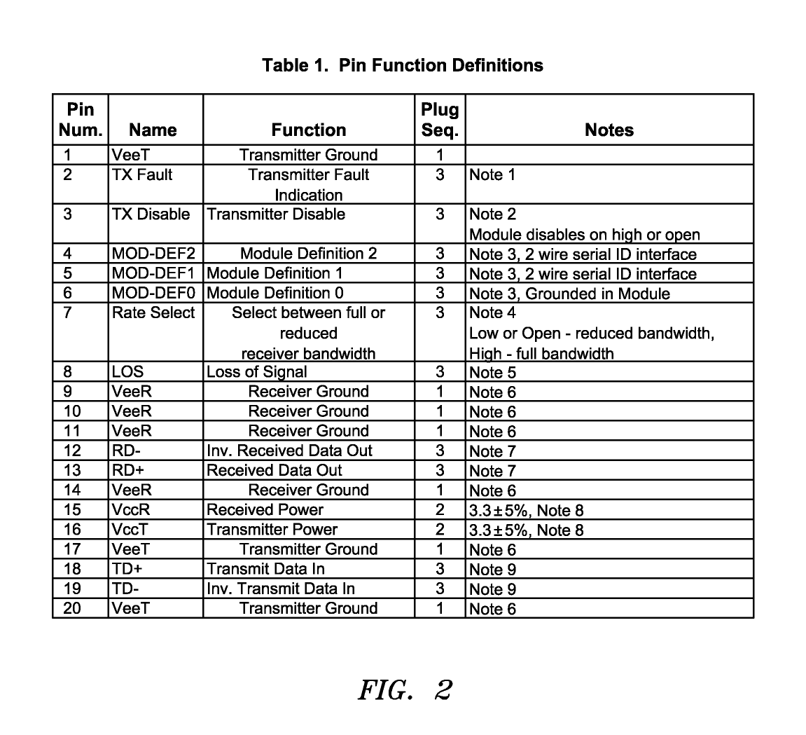

In at least one embodiment of the pluggable synchronization clock 10, a system clock synchronization subsystem 12 is embodied in an HPT 18 that complies with the SFP standard. FIG. 2 is drawn from the SFP Multi-Source Agreement, and lists the signals of the electrical interface of SFP transceivers relevant to host system interface 14.

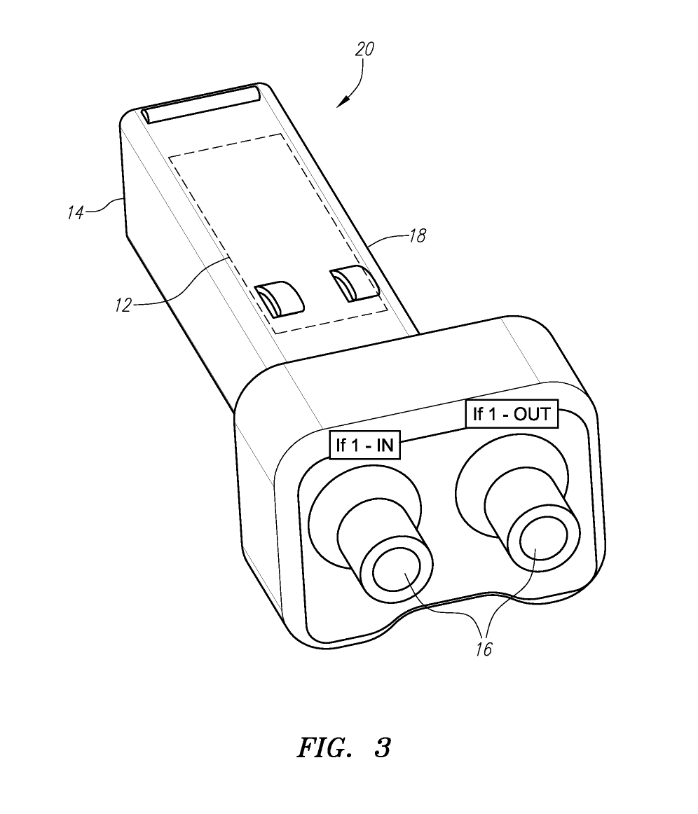

FIG. 3 illustrates an exemplary implementation of one embodiment of a pluggable synchronization clock 20. The embodiment shown in FIG. 3 includes a system clock synchronization subsystem 12 that complies with IEEE 1588v2. System clock synchronization subsystem 12 is disposed inside an HPT 18 that complies with the SFP form factor. As may be seen by FIG. 3, pluggable synchronization clock 20 includes an external interface 16 that includes an input and output sub-interface, IF1-IN and IF1-OUT respectively. When pluggable synchronization clock 20 is interfaced with a compatible networking device, IF1-IN receives clock input signals from an external source and IF1-OUT sends external output signals based on configurable timers (ex. sourcing the regenerated clock to a wireless station), while host system interface 14 allows communication with the compatible networking device. Although a single clock related input and output is shown in the embodiment of FIG. 3, in other embodiments more than one clock related input or output may be included.

In the embodiment shown in FIG. 3, the external interfaces are shown as coaxial interfaces. However, in other embodiments, the external interfaces 16 may be any type of interface including, copper such as twisted pair RJ45, fiber optic including single mode or multi-mode fiber, or any other type of connector. For example, in one embodiment where external interface 16 is optical, system clock synchronization subsystem 12 may be hosted by an optical pluggable, where the system clock synchronization subsystem 12 may reside in the optical path. In such an embodiment, clock synchronization packets are identified, trapped to the system clock synchronization subsystem and processed. As a possible result, egress clock synchronization packets receive the exact timestamp, on their way to the optical line. Ingress clock synchronization packets are processed and as a result, the system clock is adjusted.

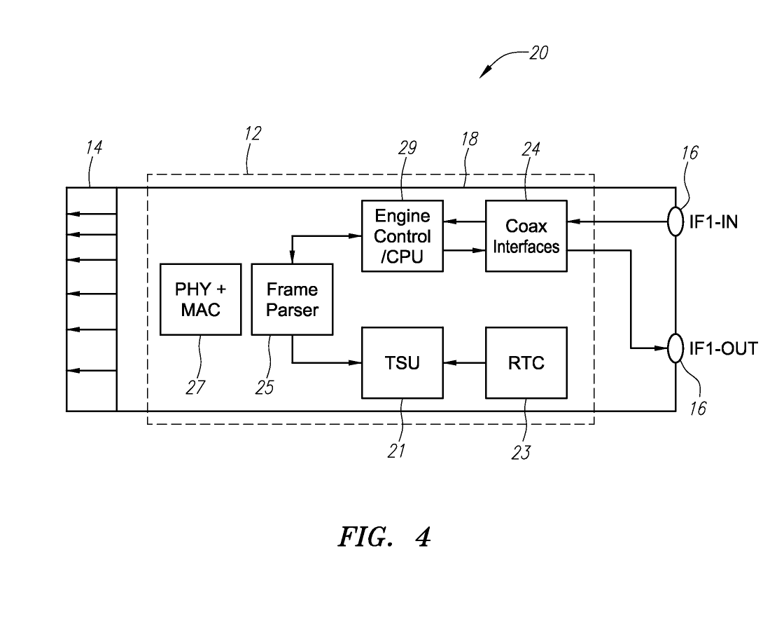

FIG. 4 illustrates one embodiment of a design architecture for a pluggable synchronization clock 20. The embodiment shown in FIG. 4 includes a central processing unit (CPU) 29. CPU 29 may be any type of processor including a microprocessor, field programmable gate array (FPGA), Application Specific Integrated Circuit (ASIC), Digital Signal Processor (DSP) or any other type of processing unit.

In a preferred embodiment, the software or instructions for allowing the CPU 29 to control the system clock synchronization subsystem 12 may be burned into the CPU 29, such as in an ASIC. In other embodiments, CPU 29 may be in communication with memory (not shown) such that the software or instructions to control the system clock synchronization subsystem 12 resides in the memory and is/are executed by the CPU 29 during operation. In yet other embodiments, some of the software and/or instructions on how to operate the system clock synchronization subsystem 12 reside on the host system and are communicated to the CPU 29 via the host system interface 14 during operation. In other embodiments, various combinations of software and instructions residing within the CPU 29, within memory, and within the host system are used.

The embodiment of the pluggable synchronization clock 20 shown in FIG. 4 further includes a real time clock (RTC) 23. The RTC 23 keeps track of time and provides the time to the system clock synchronization subsystem 12. The RTC 23 may be any type of RTC 23 including those driven by a precise crystal oscillator. Furthermore, although the RTC 23 is shown as a separate component in the embodiment of FIG. 4, in other embodiments the RTC 23 may be an integrated part of the CPU 29.

The embodiment of the pluggable synchronization clock 20 shown in FIG. 4 also includes a time stamp unit 21 (TSU). The time stamp unit stamps frames with the current time from the RTC 23. In a preferred embodiment, the TSU 21 is implemented in hardware to allow for extremely fast and accurate stamping of frames. However, in other embodiments, the TSU 21 may be implemented in software. For example, the frame could be passed to the CPU 29, which would retrieve the time from the RTC 23, and then insert the time stamp into the frame using software. In yet another embodiment, an external coax interface 24 clock input signal (IF1-IN) may be used to generate timestamps. For example, the signal information may be provided to the pluggable synchronization clock 10 through the host system interface 14, and then used by the pluggable synchronization clock 10 to time-stamp the frames.

The embodiment shown in FIG. 4 further includes a frame parser 25, and PHY+MAC 27. The frame parser 25 sits between the PHY and the MAC and analyzes the frame's contents and extracts the fields necessary before forwarding the frame to the CPU 29 or TSU 21. The PHY+MAC 27 handle the lowest levels of operation in data communication devices. The PHY connects the link layer device (MAC) to the physical medium.

In one embodiment of pluggable synchronization clock 10, the system clock synchronization subsystem 12 conforms to the Precision Time Protocol (PTP). The PTP was first standardized by the IEEE in 2002 as IEEE-1588. In 2008, an enhanced version two (2) was released (also known as PTPv2 or IEEE 1588v2). In preferred embodiments, the system clock synchronization subsystem 12 supports IEEE 1588 and more preferably IEEE 1588v2. Both versions of IEEE 1588 are incorporated by reference herein. “PTP” is used hereinafter to refer to either version of the IEEE 1588 standard. The present patent document describes a system clock synchronization subsystem 12 that complies with the PTP, however, other embodiments may implement other packet-based clock synchronization protocols, methods and mechanisms. In various embodiments, different protocols may be implemented over any data protocol.

In embodiments where a specific protocol or protocols are implemented, such as the PTP, the protocol may be implemented by the hosting system processor, by the CPU 29 residing on the HPT 18, or a combination of both. The system clock synchronization subsystem 12 provides accurate time stamping for the purpose of implementing time synchronization protocols such as the PTP but does not necessarily have to implement the protocol itself. In one embodiment, the in-band access may be used to implement the distributed system clock synchronization protocol. In this case, the system clock synchronization subsystem 12 may assists the hosting system CPU in the implementation of the system clock synchronization protocol. The control of the system clock synchronization subsystem may be performed through a proprietary in-band protocol. The in-band interface is the path for incoming and outgoing protocol message detection and/or processing, for either of the processor architectures (internal or external).

The PTP is an industry standard protocol that enables the precise transfer of frequency and time to synchronize clocks over packet based Ethernet networks. In operation, devices that reside on a communication network that wish to have their system clock synchronized with other device system clocks may include an embodiment of the pluggable synchronization clock 20 running the PTP. The PTP selects a single grandmaster clock from the available devices attempting to synchronize their clocks and then designates the remainder of the devices as slave clocks. The slave clocks are then synchronized with the system grandmaster clock. The PTP uses traffic time stamping, with sub-nanosecond granularity, to deliver the very high accuracies of synchronization needed to ensure the stability of base station frequency and handovers.

Timestamps between master and slave devices are sent within specific PTP packets by the pluggable synchronization clock 10 and in its basic form, the protocol is administration free. Of course, the precision and performance of the PTP is based on the precision of the timestamp by the TSU 21. Accordingly, it is preferably that the timestamp is performed by hardware in the TSU 21 instead of software.

The timestamps of incoming and outgoing packets need to be recorded and assessed to ensure synchronization of the various device's system clocks. Although in various embodiments, the implementation of the system clock synchronization protocol, such as the PTP, may be distributed in different amounts between the CPU residing on the system and the CPU 29 residing on the pluggable synchronization clock 10, the protocol must determine any variation in time between the slave clock and the master clock and update the device system clock accordingly. Differences in time and frequency between master and slave clocks may be evaluated based on the time stamps of the PTP packets. Clocks of each device must be measured to ensure they are within their specified limits and subsequent equipment corrections evaluated. In determining whether any equipment timing corrections are necessary, delays and drifts in sync and their effect on the transfer of timing through the network need to be considered.

When implemented correctly, the PTP is capable of providing high precision timing for large networks. The PTP employs short synchronization frames (to save network bandwidth), transparent clocks to avoid exponential error propagation in cascaded networks, as well as unicast connections to allow the synchronization of devices over long distance connections or via devices not supporting PTP (e.g. routers). The PTP provides configuration sets used by specific devices, known as “profiles”, thus simplifying the configuration of the nodes and guaranteeing the proper behavior and performance for specific systems.

Depending on whether a device is a master or a slave, the number of ports the device has, and the devices role in the network, a different type of PTP clock may be instantiated by the PTP protocol on the device. Table 2 lists the five different types of clock devices defined by the PTP.

TABLE 2
PTP Types of Clock Devices.

| PTP Clock | |
|---|---|
| Type | PTP Clock Description |
| Ordinary | A single port device that can be a Master or Slave clock. |
| clock | |
| Boundary | A multi-port device that can be a Master or Slave clock. |
| clock | |
| End-to-end | A multi-port device that is not a Master or Slave clock but a |
| Transparent | bridge between the two. Forwards and corrects all PTP |
| Clock | Messages. Correction achieved by addition of the bridge |
| | residence time into a correction field within the header |
| | of the message. |
| Peer-to-peer | A multi-port device that is not a Master or Slave clock but a |
| Transparent | bridge between the two. Forwards and corrects Sync and |
| Clock | Follow-up messages only. Correction achieved by addition |
| | of the bridge residence time + the peer-to-peer link delay, |
| | into a correction field within the header of the message. |
| Management | A device that configures and monitors clocks. |
| Node | |

Master and slave network devices are kept synchronized by the transmission of time stamps sent within the PTP messages. The time stamps may be provided by the TSU 21. There are two (2) types of messages in the PTP protocol: Event Messages and General Messages. Event Messages are timed messages whereby an accurate time stamp is generated both at transmission and receipt of the message. General Messages do not require time stamps but may contain time stamps for their associated event message. The various PTP messages defined by the IEEE 1588v2 standard are described in Table 3.

TABLE 3
PTP Message Types.

| Event Messages | General Messages |
|---|---|
| Sync | Announce |
| Delay_Req | Follow_up |
| Pdelay_Req | Delay_Resp |
| Pdelay_Resp | Pdelay_Resp_Follow_Up |
| | Management Signaling |

In order to correctly sync the master and slave clocks of different devices, the propagation delay between devices must be accurately measured. The PTP provides two mechanisms to measure the propagation delay between PTP ports: 1) The Delay Request mechanism; and 2) The Peer Delay Mechanism. The Delay Request Response Mechanism uses the messages: Sync; Delay_Req; Delay_Resp; and, if required, Follow_up. The Peer Delay Mechanism uses the messages: Pdelay_Req; Pdelay_Resp; and, if required, Pdelay_Resp_Follow_Up. The Peer Delay Mechanism is restricted to topologies where each peer-to-peer port communicates PTP messages with, at most, one other such port.

Ports on Ordinary or Boundary clocks can use either mechanism; ports on end-to-end transparent clocks are independent of these mechanisms, and ports on peer-to-peer transparent clocks use only the peer delay mechanism. It should also be noted that the two mechanisms do not inter-work on the same communication path.

Once the protocol is initiated, there are two phases in the normal execution of the protocol: Phase 1 establishes the Master-Slave hierarchy; and Phase 2 synchronizes the clocks using either of the two above described mechanisms.

Master-Slave hierarchy is established between any pair of ports running PTP. In each port of any device that includes an Ordinary or Boundary clock, there is a PTP state machine. These state machines use the ‘Best Master Clock Algorithm’ (BMCA) to establish the Master clock for the path between two ports. The statistics of the remote end of a path are provided to each state machine by the Announce message. Since the local clocks statistics are already known by the state machine, a comparison can be made as to which is the best Master.

A method for synchronizing ordinary and boundary clocks using the Delay Request-Response Mechanism will now be described. After the Master-Slave hierarchy has been established, the clock synchronization phase can start. The clock synchronization phase consists of the exchange of PTP timing messages on the communication path between two devices that include PTP clocks. For example, two devices that include a pluggable synchronization clock 20. There are two parts to this synchronization method: 1) Measuring the propagation delay between Master and Slave; and 2) Performing the clock offset correction.

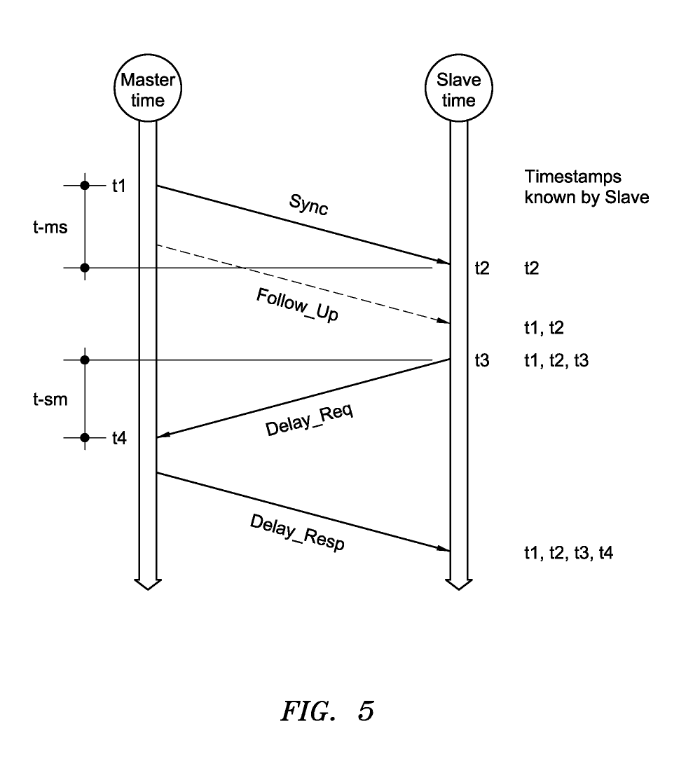

Measuring the propagation delay between Master and Slave is performed using the Delay Request-Response Mechanism. FIG. 5 illustrates a master and slave device implementing the Delay Request Response Mechanism defined by the PTP. At time t1, the Master sends a sync message (and optionally a Follow_Up message) to the Slave with the time stamp of the Master at the time of sending. The Slave receives the sync message at time t2. The Slave then sends a Delay_Req Message to the Master with the time stamp of the Slave time at the time of the sending of the Delay_Req Message (t3). The Master receives the Delay Req Message at time t4, and sends a Delay Response Message back to the Slave with the time t4. Table 4 lists a description of t1-t4.

TABLE 4
Propagation Delay Times.

| Time | Description |
|---|---|
| t1 | Master Time at point of sending Sync Message. |
| t2 | Slave Time at point of receiving Sync Message. |
| t3 | Slave Time at point of sending Delay_Req Message. |
| t4 | Master Time at point of receiving Delay_Req Message. |

Once the Slave knows the timing of t1, t2, t3, and t4, it can calculate the mean propagation delay (TMPD) of the messages path. This is calculated using the following equation:

$$\frac{( t 2 - t 1 ) + ( t 4 - t 3 )}{2}$$

The Sync and optional Follow_Up messages give the master to slave message propagation time (t-ms). The Delay_Req and Delay_Resp messages give the slave to master message propagation time (t-sm). Any asymmetry between t-ms and t-sm introduces an error into the clock offset correction.

Once the propagation delay is known, the Master can send the sync message and the optional Follow_Up messages containing its master timestamp. Because the propagation delay between the Master and the Slave is known by the Slave, the clock correction can occur in the Slave device and the Slave can sync its clock with the Master device.

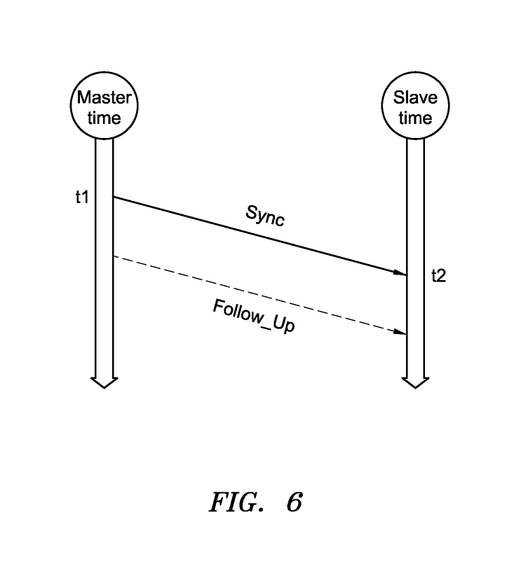

FIG. 6 illustrates the basic synchronization message exchange. Devices that can not accurately time-stamp their messages in hardware use the Follow_Up message to convey the precise time stamp of the Sync message. The Slave uses the Sync message time stamp to sync its clock with the master by performing a clock offset correction. The Slave clock offset from the Master clock is given by the equation:

t2−t1−TMPD

The above is a simple model that does not show any end-to-end transparent clocks. Transparent clocks were added in version two of the IEEE 1588 standard released in 2008. End-to-end transparent clocks do not serve as Master or Slave clocks but they do insert/update a correction field into event messages that allows adjustment of timestamps at the Slave device to remove residence times through any transparent clock devices/bridges. The above model would not include any peer-to-peer transparent clocks as these cannot coexist on the same communications path as the Delay Request-Response Mechanism.

As an alternative to the Delay Request Response Mechanism, devices may sync their boundary clocks using the Peer Delay Mechanism. Similar to the Delay Request Response Mechanism, the Peer Delay Mechanism is initiated after the Master clock has been selected. There are two parts to synchronizing boundary clocks using the Peer Delay Mechanism. First, the link propagation delay is measured and then the clock offset correction can be performed.

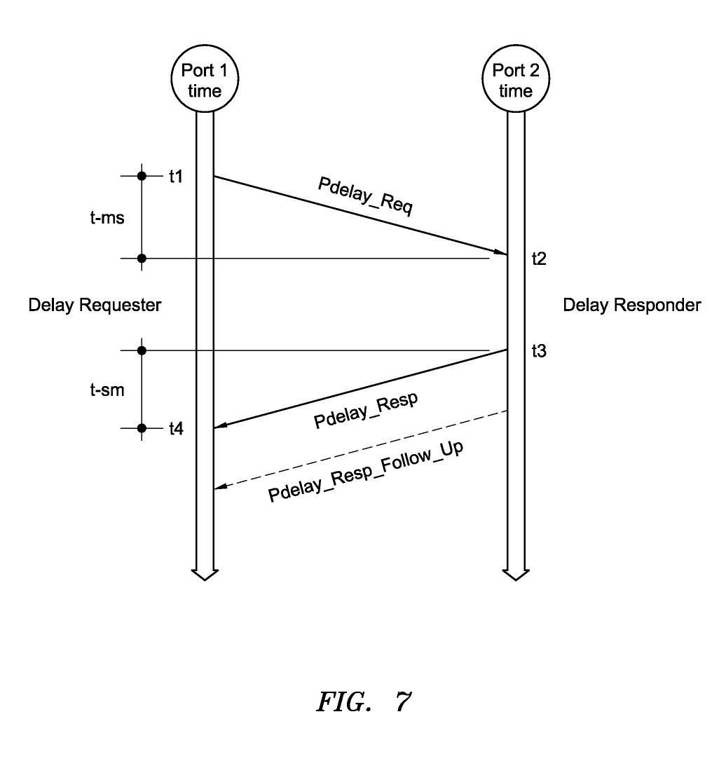

FIG. 7 illustrates two ports, Port 1 and 2, syncing their boundary clocks using the Peer Delay Mechanism. In the Peer Delay Mechanism, Port 1 sends out a Pdelay_Req message time stamped with the time it was sent (t1). Port 2 receives the Pdelay_Req Message and time stamps the message with the time it was received at Port 2 (t2). Port 2 then responds to Port 1 with a Pdelay_Resp message that is time stamped with the time it leaves Port 2 (t3) and also includes the time (t2) that Port 2 received the Pdelay_Req message. As shown in FIG. 7, Port 2 may need to send a Pdelay_Resp_Follow_Up message. When Port 1 receives the Pdelay_Resp message it records the time it was received (t4). Table 5 lists a description of the Link Delay Measurement times.

TABLE 5
Link Delay Measurement Times.

| Time | Description |
|---|---|
| t1 | Port 1 Time at point of sending Pdelay_Req Message. |
| t2 | Port 2 Time at point of receiving Pdelay_Req Message. |
| t3 | Port 2 Time at point of sending Pdelay_Resp Message. |
| t4 | Port 1 Time at point of receiving Pdelay_Resp Message. |

Once Port 1 knows the timing of t1, t2, t3, and t4, it can calculate the mean link delay (TMLD). This is calculated using the following equation:

$$\frac{( t 2 - t 1 ) + ( t 4 - t 3 )}{2}$$

The device uses the TMLD when calculating the correction field for each Sync or Follow_Up message that passes through the bridge. The outgoing correction field will be the sum of the residence time, the mean link delay and any correction field from upstream ports. The Pdelay_Req, Pdelay_resp and optional Pdelay_Resp_Follow_Up messages allow the round trip link delay to be calculated (t-ms+t-sm). Any asymmetry between t-ms and t-sm introduces an error into the clock offset correction.

Once the TMLD has been calculated the Slave devices may perform the clock offset correction. Referring back to FIG. 6, the Slave uses the Sync message or the optional Follow_Up message to calculate the clock offset from the Master to the Slave. This is calculated using the following equation:

t2−t1−correctionField

A benefit of peer-to-peer path correction is that the path delay of each individual Sync or Follow_Up message is calculated as it travels along the communication path. It is therefore not affected by a change to the path. When using the Peer Delay Mechanism the clock synchronization does not require the return path to be calculated as it does in the basic exchange, i.e. the Delay_Req, Delay_Resp messages shown in FIG. 5. The path delay between the Master and Slave in the Peer Delay Mechanism is simply contained within the correction field of each Sync or Follow_Up message. Including the path delay within each Sync or Follow_Up message has the added benefit of reducing the processing of the Master because it will not receive any Delay_Req messages. Reducing the processing of the Master may be a major benefit in linear topologies, when many slave clocks are connected to a single master.

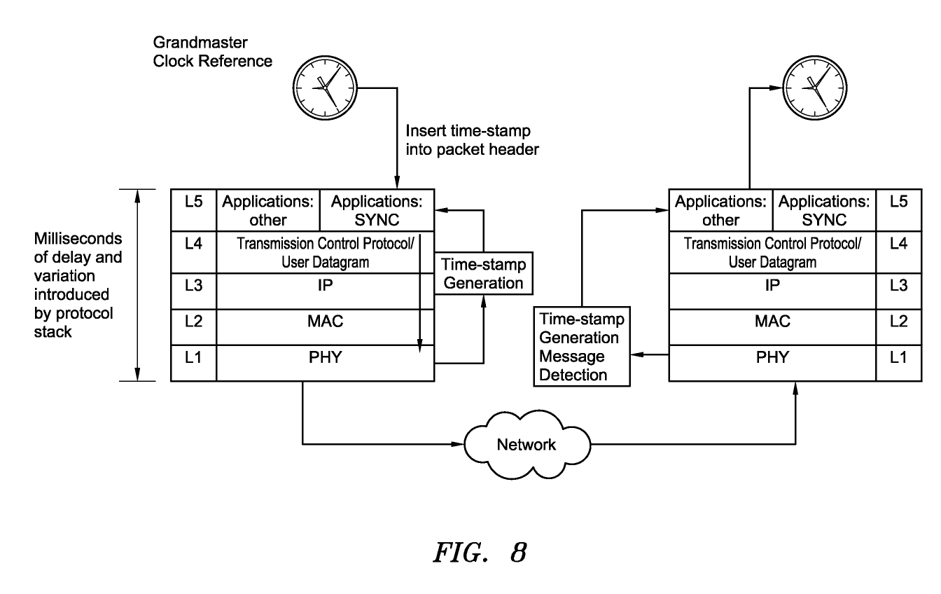

FIG. 8 illustrates a top-level overview of a Master-Slave architecture for implementing PTP. During implementation the time stamps are extracted from the packet headers. The system time is then reconstructed from the extracted time stamps. Filtering and smoothing are applied as necessary.

The PTP may be transported over many different protocol types and the pluggable synchronization clock 10 may be adapted to support such protocols. Preferably, the pluggable synchronization clock 10 is adapted to run the PTP over UDP using IPv4. However, in other embodiments, other combinations of protocols may be used. For example, the pluggable synchronization clock 10 may be adapted to run the PTP over UDP using IPv6, IEEE 802.3/Ethernet, DeviceNET, ControlNET, IEC 61158 Type 10 (Fieldbus) or any other type of data transport protocol.

In PTP over UDP using IPv4 or IPv6 over Ethernet, the first byte of the PTP message immediately follows the final byte of the UDP header. The UDP port identifies the UDP datagram as a PTP message. In PTP over IEEE 802.3/Ethernet the first byte of the PTP message occupies the first byte of the client data field of the Ethernet frame. The Ethernet type field is set to 0x88F7 and identifies the client data field as a PTP message.

Although numerous embodiments of the present invention include a system clock synchronization subsystem 12 embodied in a HPT, other embodiments encompass the operational and functional combination of HPTs including a system clock synchronization subsystem 12 with networking equipment designed to interface with HPTs. For example, one embodiment of the present invention includes an Ethernet router with an HPT interface including a HPT with a system clock synchronization subsystem 12 embodied therein. Another embodiment includes a data communication network with a first communication device including a HPT 18 with a system clock synchronization subsystem 12 and a second communication device including a HPT 18 with a system clock synchronization subsystem 12. Other embodiments consist of the software-enabled operational of an HPT 18 including a system clock synchronization subsystem 12.

In addition to providing an easy way to sync the system clock of the host device, other embodiments may also provide external signals that may be used to sync other clocks. For example, in one embodiment the system clock synchronization subsystem 12 generates a sync signal and outputs it to other devices. The sync signal may be output via the host system interface 14, external port 16, or an additional interface designed specifically for such signal. In one embodiment, variable external clock frequencies or an external PPS signal are generated for accuracy measurements.

The various embodiments of the pluggable synchronization clock described above may be used to provide the existing installed base Carrier Ethernet devices with an HPT interface (switches, routers, NIDs) with the capability of adding support for system clock synchronization protocols such as IEEE 1588v2 at the resolution required by wireless-backhaul installations (for ex. sub-100 nanosecond resolution, 1 pps, 10 MHz, etc.). In addition, embodiments of the pluggable synchronization clocks described herein may be used to generally synchronize different systems with independent clocks. Such synchronization may be used in Carrier Ethernet (and others) network testing, like Y.1731, MEF 10, MEF 17, and others.

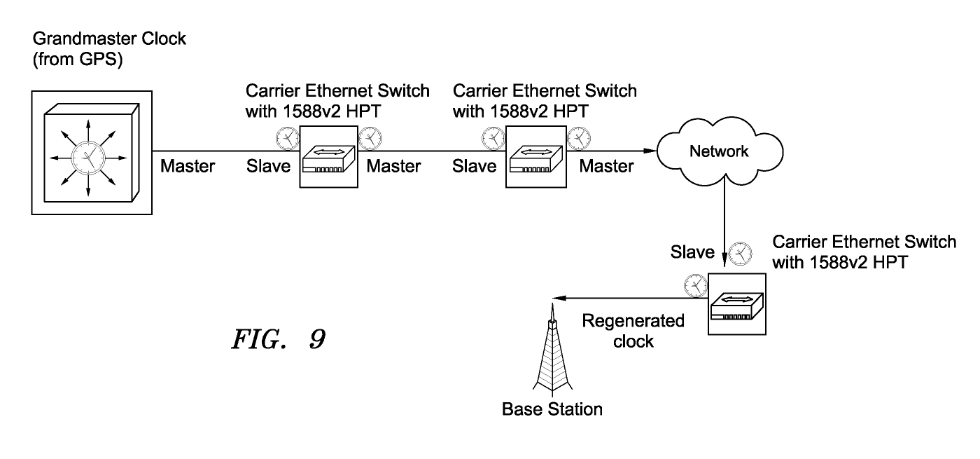

FIG. 9 illustrates a network running PTP for use in describing one example implementation of embodiments of the pluggable synchronization clock. In the example shown in FIG. 9, a Carrier Ethernet Switch receives the Master Clock. Multiple Carrier Ethernet Switches on the path have or do not have native IEEE 1588v2 clock synchronization support. The addition of an embodiment of the pluggable synchronization clock describe herein in these devices enables the boundary clock functionality (slave for ingress from previous master and respectively master for next in chain). A Carrier Ethernet Switch located at the edge of the Carrier Ethernet network also does not have native support for IEEE 1588v2 clock synchronization and generation. The addition of an embodiment of the pluggable synchronization clock described herein enables the functionality in the edge switch. By adding an embodiment of the pluggable synchronization clock, the Carrier Ethernet Switch can accurately run the IEEE 1588v2 protocol. The recovered clock may be supplied to a Base Station BTS.

In another example of how embodiments of the pluggable synchronization clocks described herein may be implemented, two edge Carrier Ethernet Switches do not have native support for hardware-based clock synchronization. With the addition of an embodiment of the pluggable synchronization clock, the edge Carrier Ethernet Switches are capable of synchronizing their clocks. As a result, the two systems can accurately run all the Y.1731/MEF 17 IA SLA assurance tests, including the challenging unidirectional latency (delay measurement DM) and jitter (delay variation DV) testing.

Although the embodiments have been described with reference to the drawings and specific examples, it will readily be appreciated by those skilled in the art that many modifications and adaptations of the processes and apparatuses described herein are possible without departure from the spirit and scope of the embodiments as claimed herein. Thus, it is to be clearly understood that this description is made only by way of example and not as a limitation on the scope of the embodiments as claimed below.

What is claimed is:

1. A pluggable synchronization clock comprising:
a pluggable transceiver; and
a system clock synchronization subsystem embodied within the pluggable transceiver.

2. The pluggable synchronization clock of claim 1, wherein the system clock synchronization subsystem is adapted to implement a packet-based precision time protocol.

3. The pluggable synchronization clock of claim 2, wherein the packet based precision time protocol conforms to the IEEE-1588v2 standard.

4. The pluggable synchronization clock of claim 1, wherein the system clock synchronization subsystem is adapted to perform a first portion of the packet based precision time protocol and further adapted to interface with a host system adapted to perform a second portion of the packet based precision time protocol.

5. The pluggable synchronization clock of claim 1, wherein the system clock synchronization subsystem includes a time stamp unit.

6. The pluggable synchronization clock of claim 5, wherein the timestamp unit is adapted to time stamp a frame in hardware.

7. The pluggable synchronization clock of claim 5, wherein the timestamp unit is adapted to time stamp a frame in software.

8. A pluggable transceiver comprising:
a system clock synchronization subsystem;
a first interface in communication with the system clock synchronization subsystem and adapted to receive packets from an external network; and
a second interface in communication with the system clock synchronization subsystem and adapted to communicate with a host system.

9. The pluggable transceiver of claim 8, wherein the system clock synchronization subsystem further comprising a time stamp unit.

10. The pluggable transceiver of claim 8, wherein the system clock synchronization subsystem is adapted to process packets that conform with a precision time protocol.

11. The pluggable transceiver of claim 10, wherein the precision time protocol conforms with the IEEE-1588v2 standard.

12. The pluggable transceiver of claim 8, wherein the system clock synchronization subsystem is adapted to perform a portion of a precision time protocol and further adapted to communicate over the second interface with a host adapted to perform a second portion of the precision time protocol.

13. A method of synchronizing a time of a first clock with a time of a second clock comprising the steps of:
receiving information about the time of the second clock on a first interface of a pluggable transceiver; and
sending information about the time of the second clock on a second interface of the pluggable transceiver to a host device of the first clock.

14. The method of claim 13, further comprising the step of synchronizing the time of the first clock with the time of the second clock.

15. The method of claim 13, wherein the host device of the first clock is also the host device of the pluggable transceiver.

16. The method of claim 13, wherein a host device of the second clock is also the host device of the pluggable transceiver.

17. The method of claim 13, wherein the information about the time of the second clock is adapted to a precision time protocol standard.

18. A method of synchronizing a time of a device clock with a master clock comprising the steps of:
receiving packetized information about the time of the master clock from a pluggable transceiver;
calculating a transit time of the packetized information between the master clock and the device clock; and
synchronizing the device clock with the master clock.

19. The method of claim 18, wherein the device clock is a component of a wireless base station.

20. A networking device with a system clock synchronization capability comprising:
memory;
a processor in communication with the memory;
a system clock in communication with the processor; and
executable instructions residing in the memory and adapted to be executed by the processor, wherein the executable instructions are designed to receive clock information from a pluggable transceiver via a host system interface and use the clock information to synchronize the system clock.

21. The networking device of claim 20, wherein the clock information is received in a packet format that is adapted to a precision time protocol standard.
